(19) United States
(12) Patent Application Publication
(10) Pub. No.: US 2015/0170112 A1
(43) Pub. Date: Jun. 18, 2015

(54) SYSTEMS AND METHODS FOR PROVIDING MULTI-CURRENCY PLATFORMS COMPRISING MEANS FOR EXCHANGING AND INTERCONVERTING TANGIBLE AND VIRTUAL CURRENCIES IN VARIOUS TRANSACTIONS, BANKING OPERATIONS, AND WEALTH MANAGEMENT SCENARIOS

(71) Applicant: Erly Dalvo DeCastro, Miami, FL (US)

(72) Inventor: Erly Dalvo DeCastro, Miami, FL (US)

(21) Appl. No.: 14/506,651

(22) Filed: Oct. 4, 2014

Related U.S. Application Data
(60) Provisional application No. 61/887,308, filed on Oct. 4, 2013.

(51) Int. Cl. G06Q 20/00; G06Q 20/38

(52) U.S. Cl. CPC G06Q 20/00; G06Q 20/381

(57) ABSTRACT

The present invention relates to systems, devices, and methods for conducting financial transactions, digital asset exchanges, and multi-currency interoperability on a private network of member subscribers in communication with other commercial banking and finance networks and services, where the system includes a specially adapted currency storage and conversion card apparatus, the card further comprising means for executing said transactions and exchanges using one or two or more currencies, where at least one of said currencies in preferred embodiments is a virtual digital currency hosted on said private network and combining features of both decentralized and centrally-regulated cryptocurrency systems; as well as a host of hardware and software means for integrating all of the above advantageously in various contingencies and circumstances.

### BACKGROUND OF THE INVENTION

This application is a non-provisional claiming the priority benefits of U.S. Provisional Application No. 61/887,308 filed Oct. 4, 2013, which is hereby incorporated by reference in its entirety for all purposes.

1. Field of the Invention

The present invention relates to systems, devices, and methods for conducting financial transactions, digital asset exchanges, and multi-currency interoperability on a private network of member subscribers in communication with other commercial banking and finance networks and services, where the system includes a specially adapted currency storage and conversion card apparatus, the card further comprising means for executing said transactions and exchanges using one or two or more currencies, where at least one of said currencies in preferred embodiments is a virtual digital currency hosted on said private network and combining features of both decentralized and centrally-regulated cryptocurrency systems; as well as a host of hardware and software means for integrating all of the above advantageously in various contingencies and circumstances.

2. Description of the Related Art

The following review of related art is intended to provide edifying examples of problems and pitfalls in the design and use of integrated, networked, multi-currency digital finance, banking, merchant, credit, and currency systems. The mention of these examples does not constitute an admission that any of the following methods or devices constitute prior art applicable to the present invention. The discussion of the references states what their authors assert, and the applicant reserves the right to challenge the accuracy and pertinency of any of the documents cited herein.

Money, which comprises currency in various alternate forms, has at least three intrinsic uses: (1) it is a means for exchanging discrete quanta of value; (2) it is a means for storing measurable quanta of value; and (3) it is a standard-based unit of account. A fiat currency typically represents money in a tangible form and it has four desirable traits: (i) divisibility; (ii) durability; (iii) fungibility; and (iv) verifiability. Recently, innovations have expanded the definition of money into the realm of digital assets and crypto-currencies which represent store of value in discrete data structures handled by modified peer-to-peer networking algorithms and other computer-implemented regimes.

Typical digital currency systems comprise a server including a database for associating an account with a unique alphanumeric code. The account is a record of funds stored in an electronic file and/or record that stores the sum of currency, in a unique account or an existing account along with a documented and secure record, that designates the sum of money as particularly associated with the alphanumeric code. The unique alphanumeric code may be a randomly generated alpha and/or numeric code generated by the server, or an alpha and/or numeric code provided by the user (such as one inputted via the data entry mechanism in response to a suitable prompt). Methods and systems for generating secure codes are well known in the art. See for example, U.S. Pat. App. Pub. No. 2008/0203150 to Royce-Winston, John et al., entitled “System and Method for Creating Digital Currency,” published Aug. 28, 2008, the entirety of which is incorporated by reference herein.

Currency systems deal with dynamic information. As taught in the prior art, dynamic information may be provided by a processor located on a card, or other device, and communicated such as through a magnetic emulator. Such dynamic information may, for example, change based on time. For example, the dynamic information may be periodically encrypted differently. Dynamic information may include, for example, a dynamic number that is used as, or part of, a number for a credit card number, debit card number, payment card number, and/or payment verification code. Dynamic information may also include, for example, a student identification number or medical identification number. Dynamic information may also, for example, include alphanumeric information such that a dynamic account name is provided. See, for example, U.S. Pat. No. 8,074,877 to Mullen et al., entitled “Systems and methods for programmable payment cards and devices with loyalty-based payment applications,” issued Dec. 13, 2011, the entirety of which is incorporated by reference herein.

Payment information may be communicated in a variety of ways. For example, information indicative of the type of reward that is desired or the form of payment may be communicated via an IC chip, RFID antenna, magnetic emulator or encoder, and more recently via near field communication (NFC) means. Payment information may be structured differently for each type of communication and, similarly, may include overlapping as well as different data. For example, data indicative of the type of reward desired may be provided as discretionary data in both track 1 and track 2 of a magnetic emulator. However, for example, data indicative of the type of reward desired may be provided as a different account number for a transaction based off an RFID signal from an RFID antenna. Data may be stored on a memory and constructed by a processor such that the payment information may delivered via communication devices known in the art.

A cryptocurrency can be defined broadly as any digital medium of exchange where units are produced according to a predefined, fixed mathematical formula (typically including principles of cryptography) yielding a decentralized system of creation and distribution, so that only a certain amount of cryptocurrency is produced by the entire cryptocurrency system collectively, and so that no group or individual may accelerate, stunt or in any other way significantly abuse the production of money. Therefore, cryptocurrency is the opposite of fiat currency, which comprises a physically manifested supply of individual notes (in addition to bank ledger balances representing notes) that are printed on demand by a central authority with exclusive power to determine the total money supply in an economic system.

underlying technical system upon which all cryptocurrencies are now based was created by the anonymous group or individual known as Satoshi Nakamoto for the purpose of creating an economy within which the practice of fractional reserve banking would be fundamentally impossible. Within these systems, the safety, integrity, and balance of all ledgers is ensured by a swarm of mutually distrustful parties, referred to as miners, who are, for the most part, general members of the public, actively protecting the network by maintaining a high hash-rate difficulty for their chance at receiving a randomly distributed small fee. Most cryptocurrencies are designed to gradually introduce new units of currency, placing an ultimate cap on the total amount of currency that will ever be in circulation. This is done both to mimic the scarcity (and value) of precious metals and to avoid hyperinflation. As a result, such cryptocurrencies tend to experience hyperdeflation as they grow in popularity and the amount of the currency in circulation approaches this finite cap. Other perceived advantages of cryptocurrencies are that, compared with ordinary currencies held by financial institutions or kept as cash on hand, they are less susceptible to seizure by law enforcement. Existing cryptocurrencies are all pseudonymous, meaning that direct determination of the identities of parties to an exchange of cryptocurrency is theoretically impossible, although further protocols are required in order to devise systems that are truly anonymous. By December 2013 there were more than 60 cryptocurrencies available for trade in online markets. Hundreds of cryptocurrency specifications now exist, most are similar to and derived from the first fully implemented cryptocurrency protocol, Bitcoin, which began trading in 2009 and uses SHA-256 as its proof-of-work scheme. An alternative is Scrypt, used by Litecoin. Some cryptocurrencies, such as Peercoin, use a combined proof-of-work/proof-of-stake scheme and one Nxt, exclusively use proof-of-stake. A more esoteric proof is so-called “proof-of-burn.” Wallets are software clients operating on computers and personal electronic devices. For example, desktop wallets include the Bitcoin-QT client, Electrum, and Armory. Bitcoinwallet is a mobile client that works on blackberry and android (in the android marketplace). Cloud-based solutions (accessible via networks) include Blockchain.org, Bips, and Coinbase.

Criticism of cryptocurrency includes high risk of volatility and susceptibility to pump and dump schemes. And cryptocurrency systems can be pre-mined, have hidden launches, or have extreme rewards for the first miners. Pre-mining means currency is generated by the currency's founders prior to mining code being released to the public. It often refers to a deceptive practice, but can also be used as an inherent part of a digital cryptocurrency's design, as in the case of Ripple or Nxt. There is not only a structural dichotomy between crypto and fiat currencies, but also a functional incompatibility in most economies today. Very few cryptocurrencies can be exchanged for fiat currencies and instead can only be traded for other cryptocurrencies. Banks generally do not offer services for them and sometimes refuse to offer services to virtual-currency companies. There are political and psychological reasons for this intransigence, but also very real technical and practical barriers to integration of the two money types. Regulators in several countries have warned against the use of cryptocurrencies and some have taken concrete regulatory measures to dissuade users. Improved systems and methods comprising means for using cryptocurrency within the framework of the evolving global economic infrastructure are needed to bridge this gap.

Some of the following terms may be relevant to the subject matter herein. A Bitcoin Address is similar to a physical address or an email. It is the only information you need to provide for someone to pay you with Bitcoin or various digital currencies. An important difference, however, is that each Address should only be used for a single transaction. The Block Chain (i.e., a “block”) is a public record of digital currency transactions in chronological order; the block chain is shared between all users. It is used to verify the permanence of Bitcoin transactions and to prevent double spending. Confirmation means that a transaction has been processed by the network and is highly unlikely to be reversed; each Confirmation exponentially decreases the risk of a reversed transaction. Transactions receive a Confirmation when they are included in a block and for each subsequent block. Multiple confirmations should be received to confirm large transactions but low value or low risk transactions may be accepted on the basis of a single Confirmation. Mining is a process, often performed by third parties, of executing computer instructions to Confirm Transactions and thereby increase security; it involves making computer hardware do mathematical calculations as if on behalf of the network (or the authority operating the network, such as a digital currency provider like Bitcoin). As a reward for their services, Bitcoin miners can collect transaction fees for the transactions they confirm, along with newly created bitcoins. Mining is a specialized and competitive market where the rewards are divided up according to how much calculation is done.

The Hash Rate is a term of measure applying to the processing power of a network. For example, the Bitcoin network must make intensive mathematical operations for security purposes. When the network reached a hash rate of 10 Th/s, it meant it could make 10 trillion calculations per second. A Wallet is a digital analogy to the physical object for storing money and information. In a digital currency network, a Wallet may contain a user's private key(s) which allow access to currency allocated to it in the block chain. For example, a Bitcoin wallet can display the total balance of bitcoins it controls and lets a user pay a specific amount to a specific person. This differs from credit card use where a cardholder is charged by the merchant. Cryptography is the application of mathematics and computer science to develop and implement objects and proofs providing security to data and software. This is essential for online/digital commerce and banking. In the case of Bitcoin, SHA-256 is a method of encryption utilized in cryptography which is used, among others, to make it impossible for anybody to spend funds from another user's wallet or to corrupt the block chain. It can also be used to encrypt a wallet, so that it cannot be used without a password.

### The Relevance Of Legal Rules And Jurisdictional Boundaries

Financial rules and regulations are changing to reflect the new and different possibilities and risks associated with the use of digital currencies, which are gradually being incorporating into the legacy regulatory framework for prior art banking systems. The regulatory landscape affects both the usability and valuation of cryptocurrencies, and this landscape is in a constant state of flux, disharmony, and at any given time, perhaps even chaos. Regulation applies to money changers, money transmitters, and entities which take possession of money on behalf of a customer. In the United States, relevant laws include the BSA (Bank Secrecy Act) and AML (anti-money laundering) statutes, plus newly promulgated Bitcoin License rules from the NYDFS, which require a company to register as a money services business and to collect and store personal information about all customers. A money transmitter is a money services business that may for example accept USD for bitcoins, and transfer currencies among customers and accounts. A money transmitter must register with FINCEN as a money services business and one must register in each state. Also relevant are anti-terrorism laws and related restrictions on the use of black markets, such as “watchlists” and “chokepoints.” A foreign exchange who directs their activities and services to US customers must also register as a money transmitter in the US. Other regulations, similar and different, apply variably to other international jurisdictions and currency platforms, making the interoperability of financial networks that seek to operate across multiple jurisdictions and currencies effectively impracticable. The present invention provides solutions and innovations for ameliorating this problem, including the integration of custom-designed cryptocurrency networks in a private banking platform and network, which cryptocurrency network can serve as an intermediate medium of exchange among parties in different jurisdictions and/or using different currencies, thereby avoiding some regulatory issues, while simultaneously introducing more efficient bargaining opportunities into cross-platform commercial transaction mechanisms, and providing a superior set of options to parties seeking to interact on the most favorable and inexpensive terms. Small person-to-person transactions executed by individuals are not under the BSA.

Another point where regulation is possible is at the level of the merchant. If laws were to prohibit merchants from transacting in both cryptocurrency and a fiat currency, then consumers who wanted to use bitcoin would need a means for converting bitcoins into currency at any particular time and place, and in particular to be able to do so in a continuous method at a point of sale where the transaction with the merchant in fiat currency is the last event in the chain.

The term “crypto-currency” is sometimes regarded as short for “cryptographically-secured currency.” Namecoin is a variant of the bitcoin protocol that enables differentiation of cryptocurrencies into specialized instruments or uniquely identified coins differentiated by virtue of their carrying additional data in the underlying data structures of the bitcoin protocol. Assigning metadata to the elements of a cryptocurrency is termed “coloring” the currency. These adaptations enable a user to define and allocate shares of a corporation using digital assets, for example. Bitcoin Specific Metrics comprise parameters such as mining Pool Hash Rates and Work Distribution: determining how fast new bitcoins enter the economy. Algorithms enforced by the mining clients limit this to currently 25 coins per 10 minutes in the case of bitcoin.

U.S. Pat. App. Pub. No. 2009/0204546 to Haidar, entitled, “Electronic payment and associated systems,” published Aug. 13, 2009, explains that, in the case of both conventional magnetic stripe cards and smart cards, a major problem with the implementation of such systems is the necessity for individual traders, for example retail outlets, hotels, restaurants and the like to be equipped with special card-reading terminal equipment which, when activated, could read data on the card and provide conventionally a paper record of the transaction contemplated, the paper record conventionally being produced in duplicate and signed by the card holder in order to validate the transaction, one paper record then being kept by the card holder for subsequent checking purposes and the other being retained by the establishment with which the transaction was effected. An alternative to signing is the use of a personal identification number (PIN). The necessity for using different dedicated “point of sale” terminals has restricted the growth of such electronic transaction processing, albeit that it is now very widespread.

Likewise widespread is the very complex and sophisticated communications system which underlies this card-based transaction processing approach. Based on existing banking and credit or charge card company practices, the system has developed into a highly complex system involving substantial quantities of checking and cross-checking of the data which is captured at the point of sale terminal and this complexity, coupled with difficulties in some cases of matching individual national systems to international standards, has required the very substantial investment on a global scale by financial institutions in order to operate the system at all.

In recent years, an entirely separate technology has emerged originally directed to mobile telephones, which are now ubiquitous and all developed countries have extensive mobile telephone networks, i.e. networks of transmitting and receiving stations which are designed to communicate, originally using analogue wireless technology, but, more recently, using digital wireless technology with one another and with individual users of mobile phones. A mobile phone can be described as a transmitter receiver telephone unit which is sufficiently compact and lightweight to be carried easily by any individual.

U.S. Pat. No. 8,615,196 to Chen entitled “Portable apparatus for supporting electronic wallet” issued Dec. 24, 2013 describes a portable apparatus, comprising: a first smart card having a first interface; a second smart card having a second interface; a near-field communication (NFC) unit, coupled to the first smart card via the first interface and coupled to the second smart card via the second interface, wherein the NFC unit performs electronic transaction on either the first smart card or the second smart card according to an access command of an NFC reader; and a control circuit, for controlling the NFC unit to communicate with either the first smart card or the second smart card; wherein the first smart card supports an electronic wallet function; and wherein the portable apparatus may be a cellular phone.

In light of the above, there exists a need for improved multi-currency platforms adaptable to any currencies and regulatory environments while also enabling the seamless integration of emerging digital assets like cryptocurrencies.

### SUMMARY OF THE INVENTION

It is an objective of the present invention to provide systems, apparatus, and methods for executing financial transactions using one or more fiat currencies and a digital currency (e.g., a crypto-currency), whereby a person is enabled to use a dual-currency platform to exchange fiat money for cryptocurrency and/or to manifest a cryptocurrency as one or more of a fiat currency.

Preferred embodiments of a first mode of the present invention provide a system and apparatus, comprising dedicated hardware and logic (e.g., microchips and electronic components, software, mobile applications, server-based hosting and service provider infrastructure, crypto-currency definitions) and other means for providing a digital currency, wherein said digital currency can be stored and used in a handheld device, and wherein said digital currency is exchangeable for fiat currencies and other types of credits, “points,” rewards, miles, rebates, and such means for exchanging financial instruments. The handheld device, which either is manufactured specifically for use with the system or is operating a compatible software application of the system, receives and transmits, displays and stores the digital currency in two modes, as “cold” and “hot,” that is, in a first mode where the device is off-line and a second mode where the device is connected to a network of the system.

The device comprises logic, either in a dedicated chip or in a dedicated software application, for providing a crypto-currency and one or more currency storage means whereby said crypto-currency held in storage represents a physical manifestation a digital currency. The device further provides regularly-updated conversion rate data and means for enabling the conversion of the crypto-currency into other fiat currencies and digital currencies. The device can communicate directly with other devices of the present invention during transactions between parties using the system of the invention, or it may execute transactions via a central server or network provided by the invention. In variable embodiments, the device or an application running the software of the invention from a personal computer can transfer currencies with other devices of the invention and/or to another computer, cell phone, tablet or device on the network. Transfers/transactions may be conducted between two devices/applications in “cold” mode (i.e., cold to cold), two in “hot mode (hot to hot), and/or cold to hot/hot to cold. In particular, cold storage may apply to storage on a hard drive not connected to the internet or other network; hot storage may apply to storage available on websites for instant withdraw to specified address or in a state of active communication with a network.

It is an objective of the present invention to enable an individual to carry large sums of cash in a microelectronic device. In preferred embodiments, said device may resemble a credit card, but in other embodiments it may resemble a small computer, a key, a thumb drive, and any other object suitable for providing the features and functions described herein. The device of the invention not only provides convenience, but it assists in securing cash assets while being carried so that they are inconspicuous and cannot be physically stolen. The device represents a physical manifestation of currency and is not merely an access portal to an account on a network.

It is another objective of the present invention to preserve the value of a currency, in effect, against inflation, deflation, and other changes in value that occur in time, by providing a means for converting a Fiat currency into a crypto-currency, then storing the crypto-currency whose value is not linked to the value of the first currency.

It is another objective of the present invention to provide a means for using digital currency at everyday retailers, banks, and other places by instantly converting stored value on the invention in the form of crypto-currency to a local currency and then using said local currency at a point of sale or of other financial transaction. Retailers and other parties in said sale/transaction need not be equipped to receive or transact with digital currency, because the currency conversion occurs in the device of the invention. This method can be implemented, for example, because the device of the invention functions as a hybrid debit card with standard currency account that is recognized on the backend of the existing payment networks, despite the user of the invention possessing only a digital currency. A client associated with the systems and devices of the invention performs the currency exchange.

Transactions can include sales, payments, electronic checks, transfers, and other means of exchanging monetary value known in the art. The device can be coupled with a Dual Currency Pre-Paid Platform or Credit Card Platform to interact between two or more currencies. In a first embodiment, the invention provides a debit card/prepaid program means having a means for using a dual currency, where one is a digital currency (crypto-currency) and the other is a fiat currency. Ideally the digital currency is one recognized as money by the US Government and the fiat currency is that of a sovereign state, but private parties, multilateral groups, and any other appropriate authority may utilize the invention to establish equivalent financial transaction mechanisms without relying upon any one particular government or currency. A platform of the present invention may handle any currency, according to the preferences of the user. Advantageously, the invention can interface with network-based account to exchange digital currency for Fiat currency and then be used like a conventional debit card platform. And, participating purveyors of rewards programs (e.g., points, tokens, miles, coupons, rebates, etc.) can be converted to currency.

The present invention further comprises logic for recording, tracking, and posting transaction data and for reconciling said data not only with the central server or hosting means of the system, but also between transacting parties. Among transacting parties, for example, while one or both parties are in off-line mode, both of their devices contain stored transaction data; the first party to connect to the network of the system automatically informs the central authority of the system that certain transactions with the other have been conducted, and the subsequently connecting party(ies) are acknowledged by the system accordingly. Advantageously, the invention can track data relating to transfers and transactions (amounts, personal identifying information of the parties, date, time, currency, exchange rates, “color” features, etc.) in the device (e.g., in cold mode) and correlate said data with the system of the invention to prevent fraud and double-spending/double-billing. And advantageously, devices and applications of the invention are able to receive unverified transactions (e.g., those that are not closed on the network, like an un-cashed check). And furthermore, preferred embodiments of the device can be used to make payment at POS systems anywhere in the world.

Said logic and hardware, and their functions are enabled by features of the device including control elements such as buttons or touch-sensitive means for providing user input, a means for visual display such as a video screen having graphics capability and/or alpha numeric displays, logic and/or hardware for producing graphics for said visual display, one or more means for storage of digital information, means for data encryption and security of communications, means for transmitting and receiving wireless data, a power supply means such as a battery, and one or more micro-processors.

The systems and devices of the platform of the present invention can switch between the use of one currency and another at the push of a button or other functional control means. Thus, parties using different currencies can fluidly conduct business without needing to setup exchange parameters or negotiate at the point of execution. There may be corresponding digital wallets containing currency in one type or another on the cloud (e.g., on a user's account on the network) that may be integrated with this feature of the invention, or another device and or system (inside or outside of the system of the invention) may be setup as a compatible adjunct. In preferred embodiments, the device of the invention has a magnetic stripe or other means for interfacing with POS systems, ATM's, and other places for spending and withdrawing currencies as known in the art. The system may include POS terminals and ATMs which are specially adapted for use with devices of the present invention as part of a shared or a private financial network.

The Physical Manifestation of said Digital Currency, with its Cryto Definition, comprises one or more mathematical formulates (which may be encoded in said logic, stored in said memory, and operated by said microprocessor). These can be generated in the Cloud and accepted as having value by more than the issuer, like points, rewards and rebates. In a preferred set of embodiments, this is Currency recognized as such by a large group for exchange of goods and services, which increases and decreases in value as compared to other recognized currencies, such as the Fiat currency of a nation.

It is also an objective of the present invention to provide means for ascribing value to cryptocurrencies and other digital assets according to defined variables such as the value of a commodity in a marketplace, for example when the commodity is a gem such as a diamond, where the value of said digital assets are logically related to the real world value of said commodity in some marketplace at some specified time, according to computer-executable functions dictated by one or more modules of the system wherein logic statements that determine these relationships, values, rules, and operations are stored and executed, while also being governed by some central authority. Said authority may be a person, an institution, an algorithm, or any other designated decision-making entity. For example, a first embodiment may define the value of a diamond according to a going rate for a specified unit of that commodity in a particular marketplace, or according to a schedule defined by a regulatory agency, or according to a projection made by an actuary, and so on.

It is still a further objective of the present invention to provide a platform comprising a system wherein an array of modules interact on a network to manage transactions and transfers of ownership of multiple assets, where the multiple assets comprise different types of virtual assets, both digital representations of real world assets and digital representations of virtual assets. In preferred embodiments, a first real world asset is a fiat currency and a second is a digital currency while a third is a commodity (e.g., diamonds). Any two of these, or any number of any other assets, when digitally represented in a computer memory, may constitute the assets handled by any embodiment of the invention. For example, the platform in a first embodiment may transact between fiat currency from a national banking institution and a cryptocurrency stored within a peer-to-peer network of account-holding clients; or, the platform in a second embodiment may transact between a cryptocurrency and a commodity; or, the platform may accommodate multiple fiat currencies, multiple commodities, and one or more cryptocurrencies while offering a variety of ways to transact, exchange, and convert among all three.

As an overview, the systems, devices, and methods of the present invention enable members of, or other participants on, a network to be able to store and exchange data representing financial value inhering in various types of assets, and data representing ownership of units of those assets (e.g., the private keys corresponding to units of a cryptocurrency). In preferred embodiments, means for interacting with merchants are provided to enable the buying and selling of goods and services in an economic system using the value of said assets as currency, where the platform of the system handles the logical operations necessary to convert from one currency to another currency, or from one means for storing value to another means for storing value, as appropriate for each type of transaction that a person using the system desires to conduct. So a member of the network may possess value in the form of a cryptocurrency, while the platform transforms a specified value of said cryptocurrency into a corresponding value of a local fiat currency, or of a commodity, and so on, and vice versa. The systems then facilitates the execution of the transaction between the parties even though they entered into the bargain each using a different type of currency from the other(s), so that ultimately it is not even necessary for any party to know the identity of the currency that another party to the transaction may be using.

The primary preferred embodiment of the invention supports a cryptocurrency, including the means for mining and issuing that cryptocurrency to account holders; and, it comprises an interface device to update a card, specially adapted software applications to run said interface device, at least one application providing means for the card to interface with the platform at distinct nodes or modules therein. A card device is referred to as the DALV (a prospective tradename). A digital currency hosted by a network as part of the system interfacing with the platform has been named GEMCoin, whose structure and function are equivalent to that of the cryptocurrency, “Bitcoin,” which is well described in the prior art. An operating system or software application is executed on the DALV or on whichever module of a given embodiment of the system is being used to conduct a transaction. For example, when a transaction is conducted by software on the network comprising a dual-currency platform, the governing software application may be named the Dual Currency Operating System (DCOS), which has novel and advantageous features discussed throughout the disclosure. A Point of Interface and Reconciliation (POIR) module and/or device is provided comprising a specially adapted software or other logic means for reconciling changes in account values after transactions occur. Any of the modules and functions of the system may be provided to consumers or other participants on the network via a downloadable software application that can run natively on a local machine or personal device such as a smart phone, tablet or other portable computer, PC or other home computer, server or other networked computer, and so on. At least one such software module provides means for communication and interfacing between and among the card, the personal computing device or POIR, the network, which in preferred embodiments is called the Downloadable Application (the D-APP). The Digital Currency Transmission Platform (DCTP) is a “backend” network that comprises means for controlling, verifying, transferring, storing, and exchanging currency held in member accounts, whether fiat or digital currency, or any other representation of value. The Gateway Software enables and controls the mining or minting of GEMCoin and its validation on the network of the system, which in preferred embodiments is named the GEMCoin Mining Network (GCMN).

It is another object of the present invention to provide automated and partially automated means for selecting an optimal currency for use in a currency conversion, where said currency conversion comprises a conversion of a first fiat currency into a digital currency and a digital currency into a second fiat currency, and wherein said means comprise, for example, logic encoding means for comparing present conversion rates among any two or more currencies, selecting an optimal currency exchange rate for use in a particular situation at a particular time, and executing said conversion at said particular time in a particular location.

It is still another objective of the present invention to execute the above said transactions optimally in a particular geographic location or within the borders or jurisdiction of any given sovereign authority, whether said sovereign authority is a national government, a municipality, a state, a city-state, a specially designated legal zone such as upon the high seas or in a multilaterally-controlled protectorate or a disaster relief area, a virtual reality or cyberspace, and any other place where rules regulating currency conversions are applicable or where a financial transaction involving any exchangeable currencies may take place.

It is still another objective of the present invention to include regulatory costs or concerns as factors in the reasoning applied when determining what is an optimum means for executing a transaction in light of local, variable, or prevailing regulatory rules such as national and international financial laws, administrative rules, market-regulatory customs, guidances, and best practices, fluctuations in any of these, and the like.

Additional objects, features, and advantages of the present invention will be more readily apparent from the following detailed descriptions of some preferred embodiments thereof. The present invention is not limited in its application, details, or components merely to those set forth in the following description and illustrations. The present invention resides not merely in any one of the features set forth in this specification, but also in the particular combination of all of the features and improvements claimed. Methods and devices consistent with the present invention are capable of other embodiments. In general, the order of the steps of disclosed processes may be altered within the scope of the invention. Also, the phraseology and terminology employed herein are for the purpose of description and should not be regarded as limiting unless explicitly stated as such.

### BRIEF DESCRIPTION OF THE DRAWINGS

FIG. 1A is a top front view of a schematic diagram of a first preferred embodiment of a card device of the present invention.

FIG. 1B is a top front view of a photograph of a first preferred embodiment of a card device of the present invention.

FIG. 1C is a top rear view of a photograph of a first preferred embodiment of a card device of the present invention.

FIG. 2 is a flow chart illustrating modules and steps in the systems and methods of a first preferred embodiment of the system of the invention.

### DETAILED DESCRIPTION OF THE DRAWINGS

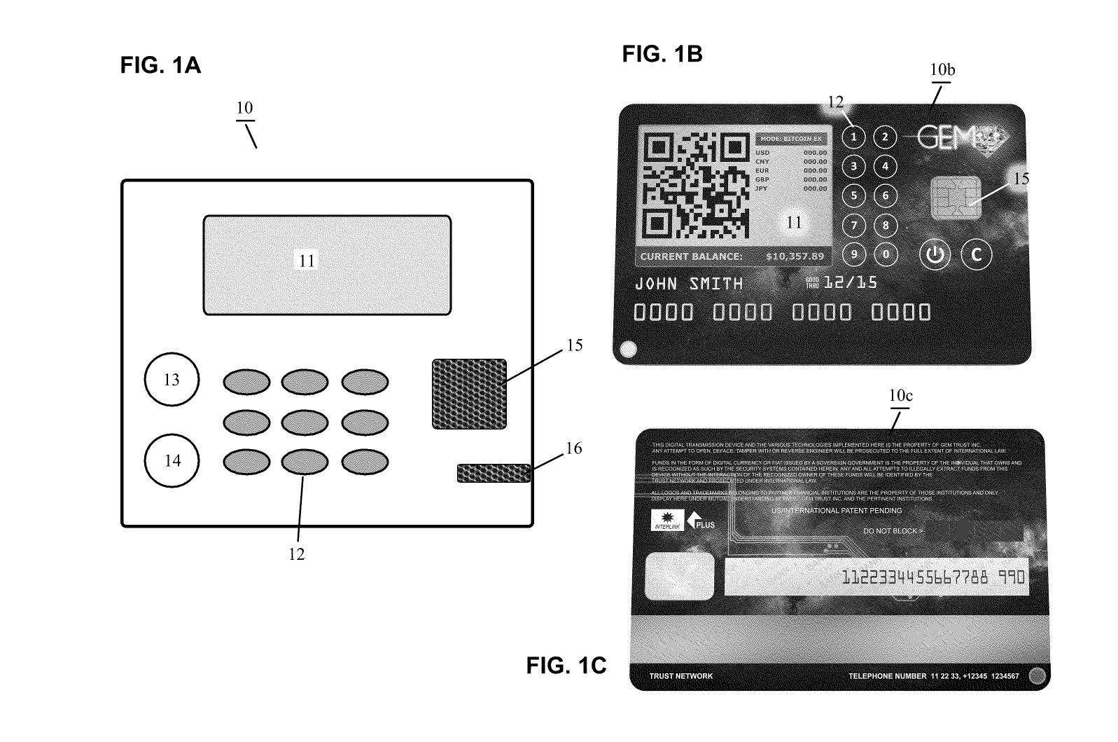

Throughout all the Figures, same or corresponding elements are indicated by the same reference numerals. FIG. 1A is a top front view of a card device 10 of the present invention in a rectangular shape. The device is not limited by the particular sizes, scales, and arrangements of the features shown in this illustration. The display screen 11 can display graphics and/or several lines of text relating to transactions information. In alternative embodiments, the display screen is enlarged (enough, for example, to encompass portions of the area of the card occupied here by the keypad) and has a touch-screen for control via a graphical user interface. The keypad 12, preferably comprising numerals, enables data entry. Special function buttons 13 and 14 execute standard functions such as converting currency, reconciling local data with a central server on a network, and/or transferring funds to another party. The device 10 may measure approximately 5 to 10 cm in length and similarly in width. The depth dimension of the device (not shown) may be anywhere from 1 to 100 mm.

A microprocessor 15 and a means for sending and receiving wireless transmission 16 may or may not be visible and/or accessible on the outside of the device 10. In other embodiments, these two features may be combined into one element. An external card or input/output socket (not shown) and the like may be positioned similarly to the communication means 16. Furthermore a socket may exist for connecting to an external power supply. A separate memory storage means for storing data electronically (not shown) may be present inside the device 10. Internally, the invention provides logic encoding means for causing the microprocessor and other internal components to maintain storage of a crypto-currency, and to perform all related operations.

When transactions occur, a QR Code or bar code may display on the screen 11 and an image capture or other means for identifying said QR Code may facilitate the step of processing the transaction. Same code may also be represented in internal logic and transmitted wirelessly. The internal logic and processor(s) of the device 10 may record the transaction and execute responsive commands locally or via the central authority (e.g., server-side hardware and software, agents on the network). An amount spent via the device may be deducted, for example, from the currency balance stored in the device and then wait for a connection to the network to update it centrally. The device 10 can also quickly download the owner's complete account information, including information relating to and resulting from previous transactions, or of the activity by transacting parties who are in privity with owner, and the like. All of these data may be displayed on the screen 11 automatically or in response to user commands in a graphical user interface or by menu navigation, and the physical controls 12-14 of the device 10 may assist the owner in generating the display of data.

FIG. 1B is a top front view of a photograph of a first preferred embodiment of a card device of the present invention. The equivalent elements are represented by numerals corresponding to those assigned in the previous drawing of FIG. 1A. Likewise for FIG. 1C, which is a top rear view of a photograph of a first preferred embodiment of a card device of the present invention. The magnetic strip at the bottom of the backside of the card may be replaced with an NFC signaling means, or may exist in parallel with an NFC signaling means in the same card, or likewise with any other means for achieving secure communication on a financial transaction network using a portable hand held device, card, or other instrument. Note that the credit card like dimensions of these preferred embodiments are not limiting, and future expanded production models are planned wherein the DALV apparatus bears a greater resemblance to a smartphone or personal electronic device, having more sophisticated electronic components, computing power, and memory storage capacity. In one such embodiment, portions of the DALV apparatus comprise transparent “glass” cases, front and back surfaces, and or touch-screen user-control panels, inspired by the sapphire smartphones emerging as popular accessories in the marketplace. For example, the Corning company manufactures one such transparent material tradenamed Gorilla Glass 3, while the relevant prior art in smartphone technologies discloses panels made of laboratory-grown sapphire, as well as less exotic plastics, or plexiglass parts. The construction of the card apparatus is not limited to the materials shown, and any suitable construction may be applied to the invention.

Methods for using the apparatus of the present invention may consist as follows. In a first example, Homeowner wants to pay Serviceman for performing a home-maintenance task. Homeowner has a card device of the present invention and the transaction amount is already stored in cold storage on the device as crypto-currency. Homeowner receives the invoice from Serviceman which has the company name and payment information thereon. Homeowner pushes a button on the front face of the card to issue an electronic check payable in US Dollars to the company of the Serviceman. Later, when Homeowner connects to the network, the transaction data is uploaded with all parameters reflecting the transaction as if it were received at the moment of upload.

In a variation of this example, Serviceman has a compatible device for receiving crypto-currency of the present invention. Homeowner pushes the button to issue the electronic payment, but no conversion to USD takes place; instead crypto-currency is transferred directly to Serviceman's company account and the compatible devices recognize the transaction as completed. Later, when either or both parties connect to the network (if neither are presently connected) the central agency reconciles its records as reflected in the data from the two devices. Both parties have an instruction on their devices but when either one connects then they all clear. Serviceman's device may be a card device (dedicated to the present invention) equivalent to that of Homeowner, or alternatively the same outcome can be achieved if Serviceman were using his own personal electronic device running a software application of the present invention, such as on a laptop PC, tablet PC, smartphone, and the like.

In a second scenario, Buyer is visiting the farm of Seller in Uruguay. Buyer has a bank account in the United States but Seller does not accept USD, and Seller has no bank account with any merchant bank. Both parties have devices of the present invention. In the push of one button, Buyer issues a payment in crypto-currency to the Seller, and the parties may decide who pays the currency exchange rate on whose end if either party needed to convert from fiat to crypto before the transaction. In such a case, the crypto-currency would have been an intermediate currency but the same transaction could have been achieved as easily as pushing one or two buttons (e.g., “convert currency,” and “pay now.”) In this example, both parties are operating on one closed network of the system in hot mode. Thus two individuals who do not use the same national currency can use the invention to make the exchange for them in one similar digital currency.

In a third scenario, Businessman wants to transfer funds to a group of Partners in a meeting, where none are connected to the Internet or to the network of the system of the invention. Nevertheless, all parties have either a device of the present invention or an application running the device of the present invention at their disposal. The Businessman transfers crypto-currency from his device directly to each of those of the Partners, and all devices are updated with information describing and identifying the relevant transaction. When the meeting is over, each Partner reconnects to the network and the central authority notes each transaction. When Businessman finally reconnects to the network, the central authority reconciles his set of transactions.

The platform of the present invention is especially useful in unstable or underdeveloped nations where the national currency and/or multiple currencies tend to be alternatively used by different segments of society, or where basic financial services are unreliable or inconvenient. And be used as quickly as a credit card or cash. Also, the invention assists individuals who travel across national borders, because the invention preserves a digital manifestation of a first money such that it can be transformed into a second money via a digital currency means as appropriate for any given set of circumstances. For example, national and international humanitarian and relief agencies (e.g., Red Cross, Unicef, Doctors without Borders) advantageously use the device of the present invention to give and send financial aid directly to victims without any party needing either a live terminal or an electrical power grid to immediately receive, store or use aid money. Also, citizens can send aid directly to victims in disasters bypassing Governments, Banks, Exchanges, Financial Gateways and Aid Agencies and NGOs; Governments can distribute welfare, social security, food stamps directly to recipients without an intermediate repository or middle man. Recipients may use the funds secured from a laptop, cell phone or any public device according to the present invention, and special-purpose devices of the present invention can be cheaply constructed and distributed to a target population, who may then use the received funds while bypassing the fees typically associated with intermediaries that exist between Aid Givers and Aid Recipients in prior art scenarios.

For example, in countries where mineral trades thrive, such where gold, silver or diamonds are mined, parties can attract buyers for those minerals by making available the platform of the present invention, for example by establishing a network and/or providing devices to the local peoples, who in many cases are villagers in areas where bank accounts and other financial infrastructure are unavailable, impractical, unaffordable, or unreliable. In many circumstances, the mere benefit of the invention's inconspicuous means of use is desirable, because violent thefts, fraud, embezzlement, and other crimes are a constant threat. The present invention enables a person to transact with foreign buyers without traveling to hot spots in order to use a banking infrastructure, or without engaging in activity that is conspicuously indicative of carrying or receiving cash. At the same time, the invention can assist in the regulation and enforcement of laws, because a government-run system may be setup to use the digital currency contained in the device and make it fully traceable by transaction and by transactor, and taxes may be assessed whereas previously the same transactions would have most likely been conducted in untraceable movements of cash.

Embodiments of the present platform enable Fiat money, such as that issued by a national government or other authority, which is held in a first savings or credit account to automatically convert one or more of a quantum of said money into a digital currency recognized internationally or, at least, recognized by the United States Government, said conversion happening in the device of the invention or on the cloud/server-side. Furthermore, conversion into a third currency may be performed afterwards. Currency conversions may take place prospectively or upon demand at the point of execution of a transaction, such as a sales transaction, and the special functions buttons 13 and 14 may be configured to execute specific types of conversions, where such functions may be customized by the user through the software of the platform, as in a web-based user interface on the server-side of the network.

The present invention can be configured independently of a population's commercial banking system such that currency stored in the device would remain therein if and when a systemic catastrophe, political crisis, or other impediment were to disable access and use of commercial bank accounts. The system would hold a digital manifestation of a physical currency that is redeemable per se, at least via the means of the digital currency, as either an alternative or an intermediary currency. Because there is a means for the physical manifestation of currency, the present invention can retain said currency with reduced risk of having the data erased or lost resulting in total loss of an account as is endemic to the bitcoin-based systems of the prior art. This device itself provides a physical means for extracting currency (e.g., into cold storage) from the cloud and keeping it in possession.

Structurally, the apparatus associated with the invention, in preferred embodiments, provides alternative power supply means including batteries (rechargeable and replacement), solar power cells, and other substitutes for any condition conceivable in the relevant art, enabling prolonged use without relying upon the infrastructure of an electrical grid.

Different embodiments of the device may be differently configured depending on the requirements of any given network service provider, owner, or other authority, any of which may operate a private network or collaborate in integrated networks. For one type of owner, daily use of the device like a debit or credit card may be desired, and therefore a card for this network may be manufactured with a magnetic stripe means and configured for making purchases of items from vending machines, kiosks, or other public and private stations. They types of currencies used by a network may also be specified, for example, conversion from Fiat Currency to Digital Currency or by using its Bar Coding or QR coding or NFC Transmission capability to initiate and complete a purchase. This highly customizable aspect of the invention enables other creative applications and micro-networks to be established, for example a school can receive payment in a book store or cafeteria, parents can provide allowances to children who are too young or ineligible for bank accounts, convicted criminals or mentally disabled or other members of society lacking capacity can receive credits for allowed spending as when on house arrest or may be denied purchase of forbidden items by using the device, fund-raising efforts can immediately reward fieldworkers with bonuses for hitting benchmarks, and so on. In these and other examples, the device may be integrated with outside apparatus such as the tracking devices worn by criminals on house arrest or the hardware installed in company vehicles and transport trucks, and otherwise configured to work directly with an existing electronic infrastructure.

As discussed previously FIGS. 1A-1C illustrated examples of a preferred embodiment of a card device (the DALV or digital Access Loading Vehicle). Preferably, the device comprises a large high-resolution screen capable of emitting color images when displaying output to a user of the device; the screen also supports high resolution monochrome or black and white output. The device comprises a security and personal identification means for using biometric data to identify a user and unlock access to the functionality of the device. In preferred embodiments said means for using biometric data comprises means for scanning the fingerprints of a person's finger when a sensor panel or equivalent assaying element is touched. This biometric data means is electronically connected to the operating logic of the microchip or other computing means in the device and activates a user interface when a fingerprint is presented that has been previously identified as representing an authorized user of the card, or of a subset of electronic features of the card. A user interface may be prompted to display in the video screen upon biometric activation of the device, or in some embodiments, customizable functions may execute simultaneously or instead, such as the execution of a transaction or of control means for executing any other function(s) according to manufacturer settings and/or user-adjustable functions. The increased size and resolution of the screen is purposed to display these expanded features not found in bank cards in the prior art, and is therefore more than a mere change in size of a screen, but instead is a new paradigm for interactivity with a credit-card-sized device.

The front surface of the card comprises a plurality of control buttons, which may be mechanical or static elements. A keypad is provided for entering numerical values into the memory of the computing element(s) in the device, and or/passwords comprising character strings while alternative modes may enable the same keys to be used for entering text and special characters, and for scrolling up and down, left and right, in the present view of the video display or within selectable menus within control panels of any selectable options within any program running on the device. Buttons may also regulate power of the device by turning it on and off, initiating a stand-by mode, sleep mode, or other powersaving routine, and the like. A preferred means for transferring data to and from the device is via NFC transmitter/receiver means for exchanging information via near-filed communication technology, radio frequency, or any other wireless means for interfacing between the card apparatus and other devices, for example another device such as a point of sale terminal (POS), magnetic stripe reader, a personal computer, another card apparatus, a public network terminal, a private network access point, or any other means for transmitting information from one device to another device in a very secure mode of communication, particularly those that comprise the encryption and decryption of data, active thwarting of spoofing and interloping by unauthorized entities and parties, and so on. Readable magnetic stripes are also provided on the cards (although these are being phased out industry-wide). The magnetic stripe of the preferred embodiments has reprogrammability features comprising means for changing the information stored in the magnetic stripe. Within the system of the present invention, data is thereby able to be exchanged in multiple ways such as from one card to another card, from a card to a terminal, from card to a cell phone, tablet PC, or other personal electronic device, and so on, and vice versa.

The card of the invention further comprises a means for storing power in a battery or other means for generating a voltage or current in an electronic device. In preferred embodiments, the means for storing power comprises a solar charging panel and a converter which function to recharge a battery on the card using energy derived from sunlight. The battery is an extended life rechargeable battery which connects to said solar converter and/or to one or more other junction means for connecting to a jack or other interface for receiving power from an external source (e.g., USB, microwave, bluetooth, thermocouple, AC jack, DC generator, and so on). The battery supplies regulated power to the computer element(s) of the card comprising at least one microprocessor (e.g., a microchip), at least one memory means for storing data on the card and for providing data to and receiving data from the computer elements of the card (e.g., a hard drive, solid state storage, random access memory, and any other memory handling means in the relevant arts), thereby enabling the card to execute software processes using logic stored in said memory means. One software application provided in the preferred embodiments comprises means for running a proprietary (i.e., customized, specially adapted, and advantageous) operating system to control the card and all of its interactions within the system of the invention and its external interfaces and points of access devices. Network browsing capabilities and communications protocols are provided in some cases, while particularized digital asset management functions are provided to handle both the standard and novel operations that the user of the card expects to perform, such as controlling the mining module of the system, operating a peer-to-peer network client application, regulating the minting, staking, transfer and tracking of private keys corresponding to assets in an account, operating a digital wallet configured for a particular cryptocurrency, and so on.

The card also includes a dual-currency operating system comprising means for integrating transactions involving two (or more) currencies, which in a prevalent type of user scenario would comprise a first fiat currency and a second fiat currency, a first digital currency and a second digital currency, fiat to cryptocurrency and vice versa, commodity-backed digital asset to any other currency and digital asset, and so on.

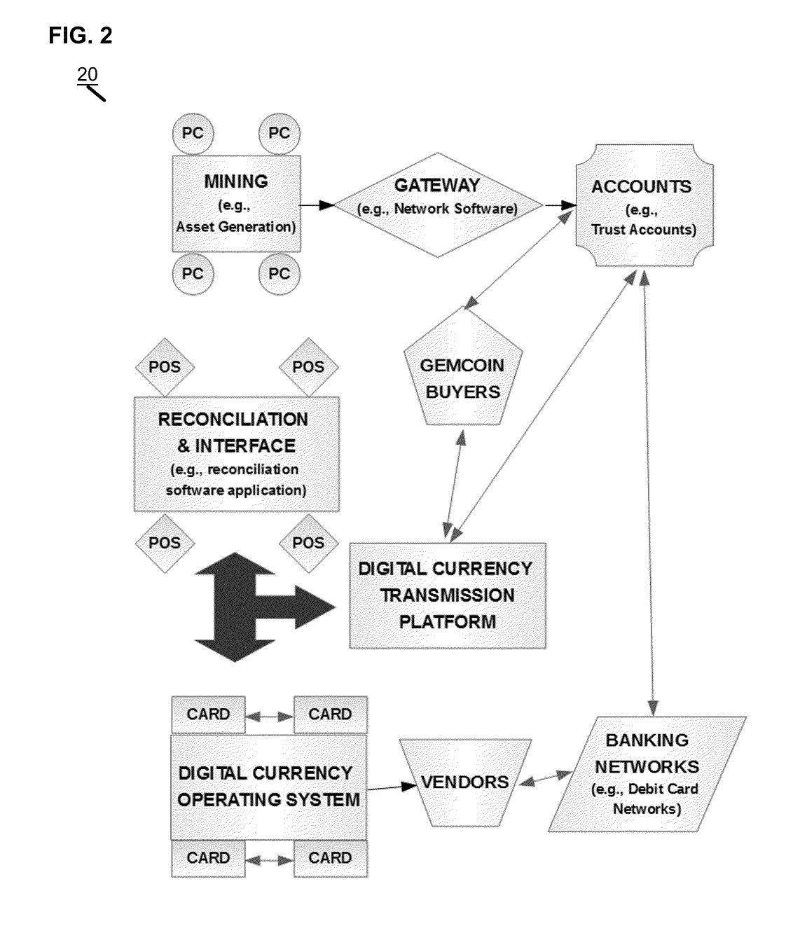

The flowchart of FIG. 2 represents a preferred embodiment of the system of the present invention wherein a multi-currency transaction device comprises a credit card (or debit card, or equivalent portable medium for financial data, currency, or other value). The mining module is accessible through a gateway to the network separating it from those locations in memory on the network where account data are stored, because mining is a separate function from the banking tools of the invention. Digital currency transmission platform conducts transactions involving digital currencies as well as other currencies and assets stored in any type of account on any local or external network, so long as it is configured for compatibility with the network. From the central focal point of the DCTP, the Reconciliation functions can be called by a microprocessor. The digital currency operating system interfaces with cards, external devices, and merchants (e.g., vendors). Banking networks may be accessed through third party hosted hardware or by relationships that give the system access to merchant account features. The cards of the present invention may have the properties of debit cards, and/or credit cards, smart cards, or any other apparatus consistent with the spirit and scope of this disclosure. GEMCoin transactions may happen within the network or may comprise a parallel system in which non-members may participate. The following is a brief summary of these functions and modules.

1. Mining GEMCoin. Miners using a software application access a gateway through which they may mine GEMCoins according to at least one mining algorithm. In preferred embodiments, said mining software comprises means for interacting with a site hosted on the internet, or a computer in a network, that is analogous to a mining pool: a network of users who have dedicated their individual computing power to the total computing power of one virtual mining operation. The embodiments of the present invention anticipate constant evolution in the algorithms used by miners, cryptocurrencies, and equivalent means for regulating the creation of digital assets, and the logic or mechanisms of the mining algorithm(s) used in conjunction with the network gateway software is not limited to proof of work, proof of stake, or any other particular means for generating a cryptocurrency or other digital asset. Additional functions of the mining software of the invention include providing validation of the authenticity of a mined or minted coin or asset and to generate the private keys or other cryptographic identifiers that represent any mined or minted coin or digital asset (i.e., to “issue” coins).

2. A network gateway is a centralized module in the network which controls the access of miners to the mining processes, on the one hand, and which controls the distribution and storage of mined coins to the individual participants in the mining operations, that is, to those owners and operators who dedicate their computing power to the mining operations and successfully generate coins thereby. The network gateway also controls the storage of issued coins in virtual wallets, the transference of data representing ownership of fiat currency or other tangible assets among addresses on a network, and to the transfer of coins and other assets into and out of individual accounts. In preferred embodiments, miners hold accounts on the platform represented by storage locations in computer memory which storage locations are individual customer accounts for storing any digital representation of value owned by the corresponding account holder, whether said value is representative of a fiat currency, a commodity, a cryptocurrency, or any other asset.

3. The digital currency transmission platform comprises means for transferring GEMcoin or any other digital asset for sale to other parties, including for sale in a marketplace that is open to the public. In preferred embodiments, the digital asset is pegged to a corresponding representation of a value of a commodity in this module, for example GEMcoin being backed by diamonds.

4. GEMcoins may be transferred or moved from owners' accounts to cardholders via the interface modules and DALVs.

5. The system enables Card to Card transference and the use of debit card networks to make purchases with any currency stored in or accessible via the Card, apparatus, or equivalent device of any embodiment of the invention.

6. DALVs are capable of interfacing directly with each other, with POS card readers on banking or merchant networks such as the MasterCard, Visa, and American Express networks, and any other interface or communication/data transfer means known in the relevant arts.

7. GEM Trust reconciles transactions and controls the exchange and interconvertibility between fiat and digital currencies, or between any two means for storing value that are represented in accounts on the platform, or accessible through the platform.

The operating system for the card's microprocessor comprises manifold and variable functional elements. A first function comprises means for storing balance information relating to an account, including digital currency accounts and fiat currency accounts, such as those provided on a cryptocurrency network and those provided by a bank that offers electronic banking services, respectively. Data may be stored in hot storage or cold storage, where hot storage comprises any means for storing data in a form accessible to the processor or network on demand, while cold storage comprises means for storing data offline where there is no communication means linking the memory element where the data are stored and the system, network, and devices of the invention unless and until a gap is closed by direct physical human action. Typically, cold storage manifests as a scenario in which a person prints the private keys or other data held in hot storage onto a paper medium while deleting the same data from its prior location within the system. At a future data, those data can be scanned back into the memory of a card or other module of the system and thus put back into hot storage. Means for achieving cold storage may be provided on the card and still physically inaccessible to the network and hardware of the computing elements of the card, where such proximal cold storage means include soft “vaults,” or virtual safe deposit boxes understood by persons of ordinary skill in the art of cryptocurrency storage and digital asset management, or temporarily connectable “hard wallets” that are analogous to portable media drives like thumb drives, but specialized for a certain type of data and extra secure against hacking or unauthorized access, also understood by persons of ordinary skill in the relevant arts.

The operating system and associated software provide means for a user of the card to keep track of recent expenditures (e.g., logging, verifying, confirming, tracking, parsing, and/or reconciling transaction data) in real time or in a lag mode when the card is used while not actively communicating with the central command module of the system such as the bank network server, or a merchant account server, or equivalent service and apparatus provided in the system of the invention, such as on a secure server in a facility in a private company. The card is able to track and control multiple types of currencies simultaneously and/or in parallel, such as digital and fiat currencies. Transactions comprise person to person exchanges of digital assets and currencies over a peer-to-peer network, or over a centralized private network; credits and debits to and from accounts represented on the card, or from an external network to the card, or from a private network to the card, from the card to a merchant at a point of sale (e.g., using a POS payment processing apparatus), to the GEM TRUST module of the system of the present invention, to and from ATMs and other banking terminals, and to or from accounts stored within the cards of parties not connected to any networks but interacting directly with each other's counterpart devices through direct or serial secure communication protocols.

An advantageous feature of the operating system is that conversion of a value of digital currency into a value of a fiat currency is accomplished within the local computing element on the card, which gives a card user privacy to conduct transactions offline and control over when to reveal the data to the central authority of the system for the purposes of reconciling the affected accounts in the main memory of the network. If and when the card is connected to cardholders' online accounts through the centralized network of the financial institution, or the peer-to-peer cryptocurrency network (e.g., the blockchain) of a cryptocurrency or equivalent digital asset, whether through an interface of the system of the invention or a third party provider such as a debit card network (e.g., via an ATM, POS or other terminal understood by persons of ordinary skill in the relevant arts), the affected account balances are updated, transactions are validated, and transactions required to be conducted or logged on the network side of the cards involved in the transactions are executed. The default operation is to automatically perform connection, exchange, and reconciliation as soon as possible when a network connection is established, but menu options in the software of the invention offer the card user control over variables in this process, such as a command prompt requiring the user to input a positive command before the system will perform said reconciliation and related actions. Thus, if desired by and permitted for a user of the system, a user may exchange value with another user of the system at a first time and in a first location by a card-to-card offline exchange transaction using the hardware and software of the cards only, and then reconcile the affected account balances with the central authority at a later time when the user is in a second location, such as on the other side of a national border, or after some contingent condition has come to pass, and so on. These offline transactions are typically regarded as “unvalidated transfers” analogous to the progression of a paper check (of legacy banking systems) that has been multiply endorsed before being deposited and cleared by a banking network. There is no limit to the depth, or the number of layers (e.g., intervening unvalidated transactions) applicable to any one coin, but which depth parameter may be restricted to within a certain range by modifying the assigned values of variables in the logic of the source code. Additionally, the previously discussed means for “coloring” coins may be employed in preferred embodiments to created a nested, short-term ledger within the offline transaction blocks, so that when any given offline block is finally reconciled centrally its history during the offline period will be found recorded in the appropriate secondary data field, as well as history about any interactions with other accounts that may have transpired as that coin made its way back to the central ledger through whatever path it followed. Thus individual blocks may be reconciled in any order received by the network, and educated guesses about the present status of other accounts through which that block or coin passed while “dark,” because some information about other offline coins or affected accounts will arrive serendipitously in the secondary data container of the colored coin or transaction block.

A significant innovation and advantage of the present invention is that the cryptocurrency module of the system comprises logic in some embodiments which provides means for executing direct transfers of coin among parties, one or more of which is offline, or not actively logged into the client application for connecting to the network which is hosting the blockchain (e.g., the consensus ledger); that is, in other words, by sidestepping the prior art's requirement that all changes to the ledger be confirmed and maintained as a consensus on a majority of nodes of the network simultaneously at all times. Instead, the present invention incorporates limited centralization to dampen any confusion that would otherwise be caused by having a population of coins offline and unreconciled by the majority consensus. This hybridization of the consensus blockchain model with a centrally monitored ledger allows the system to tolerate having coins removed from the blockchain and added back into it later without destroying the stability of the currency. This unconventional function is possible because the network is privately operated by a central authority, whereas Bitcoin and other purely “decentralized” cryptocurrencies eschew any transactions that are not reported to the entire network immediately and confirmed by the majority of nodes as a bona fide consensus. It is not possible in the prior art for parties in a cryptocurrency transaction to exchanging private keys, or to conduct a transaction, without being directly connected to the network, and to the proper consensus blockchain on the network. Because the present invention comprises a central server and means for reconciling all accounts across the entire network and all users from that central authority, which is (effectively) a partial redundancy comprising one authoritative ledger and at least one parallel consensus ledger, therefore off-chain transactions do not pose a systemic risk to the integrity of the network, but instead they merely affect the temporary visibility of coins to the network while their offline status has been changed on a local card device and before that change has been reported to and reconciled with the central authority. The central authority can intervene directly to thwart any instability that emerges if a malicious actor or catastrophic event causes a very large number of coins to go “dark,” or offline, at any one time, by directly intervening in the performance of the network to, for instance, temporarily expand the money supply, or to make educated guesses about the probable status of offline coins, and to permit some stopgap accounting to be done on a “contingent” or “temporary” basis (e.g., based upon statistical approximations, or educated guesses, or after enough is learned about the behavior of such systems, by actuarial tables) until reconciliation is achieved, where the value of the uncertainty is very small compared to the total volume of currency on the network. Separately and/or additionally, agreements may provide further safeguards and hedges to make the hybrid system even more robust and user-friendly, for example, contractually safeguards or optional modes in client software specifying that a member has opted to purchase privileges allowing him to conduct offline transactions in exchange for a security deposit or indemnification/insurance contract that holds an offline user responsible for losses resulting from miscalculation of hidden values in offline transactions or from undue delays in reconciliation, and other conditions as determined by the administrating authority. While such centralized oversight is anathema to, and expressly rejected by, cryptocurrency experts and users in the relevant fields of the prior art where decentralization and consensus are exalted, it is unexpectedly advantageous in the present invention as applied in this novel hybrid fashion to permit off-network transactions; and its benefits (enabling off-chain transactions and cross-currency conversions) far outweigh the costs resulting from slight uncertainty among members of the network as to what is the true real-time status of the ledger at any moment, because those risks can be offset by contracts, hedges, other creative financial instruments and safeguards, as well as any specific indemnities, liabilities, agreements and promises enforced by the central authority in privity with each member of the network.

Software functions of the system and the card also comprise means for determining exchange rates and for converting the balance of an account or of a transaction from denominations in a first currency to denominations in a second currency, or to any other expression of equivalent value derived by an equation defining means for converting the value of a first currency into a transformed equivalent value expressed in alternative currency or in alternative units of value. In the preferred embodiments, where the card is issued by and the network is maintained by a private company, an administrating entity in that company is the final arbiter of exchange rates and conversion values, and the executive decision-maker who sets forth the rules for determining them. That executive decision is declared throughout the network and transmitted onto the memory elements of member cards on the network for use by the software functions that request or require such information.

Because the system comprises the capacity to host a cryptocurrency, the specifications of the cryptocurrency (e.g., GEMcoin) are customizable at the discretion of the central authority or administrating entity. Specifications include logic for executing ancillary functions on top of the essential logic required to operate a cryptocurrency on a network, which ancillary functions can comprise “colored” coins. Colored coins is jargon for any feature that adds unique identifying information to a private key or digital asset, or to a transaction block in a ledger, including but not limited personal identifying information about the ownership, or chain of custody, of one or more coins of the cryptocurrency, and watermarks or distinct attributes applied for any reason to a particular coin or quantum of coins, which secondary data are represented as records within or attached to the data structure (e.g. the block(s)) representing a transaction or the transfer of coin from one client to another on the network. These “colored” data indicators persist as parcels attached to the respective coins unless the color is deliberately rewritten or removed by a subsequent operation or transaction.

Another advantage of the present invention is that the card devices of the system may interface with a variety of networks, including cellular phone networks, the internet, and any other available communications infrastructure suitable for sending transaction data to one or more other member users, where software applications on those external computers and networks (such as an application downloaded onto a smartphone, or a portal accessible on a website hosted on the internet) provide users with a range of options for connecting to the central authority and the private network no matter how many switching points or degrees of separation intervene between the user's first communication and the endpoint of the private network where reconciliation occurs. This is a significant improvement over other digital currency platforms and is made possible by the “hybridized” nature of the centrally regulated blockchain, or of the appurtenant ledger data structure, of the proprietary cryptocurrency of the system, which as explained above is hosted from the central platform of the system and controlled from the privately owned and operated mining modules, client software, and source code of the cryptocurrency (e.g., of GEMcoin), according to the executive judgment of the administrating authority.

The cards and modules of the system may receive updates on transaction data or other relevant values in a cryptocurrency separately and/or in parallel to the activity on a banking network comprising fiat currency bank account values. At any time, the values of any fiat currency or other digital asset may be converted to the equivalent value in the proprietary cryptocurrency on the network, regardless of whether a user is conducting a transaction offline or online, greatly reducing friction in the marketplace caused by incompatibilities between currencies or between disparate financial networks and marketplaces. The software of the system comprises artificial intelligence that will assist individual members with selecting the ideal mode and route for completing a desired transaction between two members, where the artificial intelligence recognizes that each party possesses a unique, presently known value in one or more accounts or asset holdings, and that given the present disparities between the parties or conditions of a desired transaction, there is an ideal, and optimally efficient, way to execute the exchange of value after considering all possible options. By being programmed to identify the various options available to transacting parties and being competent to determine the relative costs and benefits associated with each, the platform of the present invention actually streamlines the negotiation phase and reduces the costs of transaction barriers for bargain-seekers substantially in many cases, thus accelerating the velocity of the currency in the network and thereby increasing the value of the coin of the cryptocurrency hosted on the system; it makes transactions more efficient for each member, and all members, on average when they transact using the system and devices of the present invention regularly.

A variety of further advantages emerge from the systems and methods of the present invention. A user may transmit GEMcoin—and GEM TRUST—specific instructions via traditional credit card processing terminals. For example, software may be alerted to the fact that member cardholders desire to spend digital currency or fiat currency, or wish to exchange fiat for digital currency, and vice versa, in personal accounts online.

The operating system further comprises means for operating the high resolution screen of the video output display, means for operating the buttons on the card, means for operating and coordinating the hardware and software of the card. For example, the operating system provides logical functions for integrating the operation of the battery, of the computing elements of the card, of the solar charger, NFC, buttons, lights, sounds, magnetic strip, any and all input or output components, the transmission of data to and from the card and an external device or other module on the network, or other cards, terminals, or interfaces anywhere in the world; the user interface software and miscellaneous graphical outputs comprising interactive control means for operating, programming, and adjusting the functions, settings, and variable options of the card's features; and also the tracking of battery life and the regulation of the recharge cycle.

### The Digital Currency Module and Digital Currency (GEMCoin)

GEMCoin is an abbreviation for Global Electronic Money Coin. This alternative digital currency is engineered (e.g., programmed, designed) to integrate with, to complement, and to augment the DALV device and its functions. The computing elements of the device may be programmed by the manufacturer to employ any type of cryptocurrency algorithms or other digital asset management and exchange programs, as well as algorithms to facilitate the conversion of any one store of value into any other, while also offering the custom and proprietary GEMCoin as an administrator-regulated ubiquitous store of value by which any transaction can be conducted at the option of any party. The most prominent advantage the inclusion of this hybridized cryptocurrency network and its specialized GEMCoin is to guarantee that two parties can complete an exchange using a common currency, unless they negotiate for an exchange among specific currencies, such as US Dollars on the one hand for Euros on the other hand. In most cases, it will be advantageous (and for legal reasons, it may be necessary), to have each party's quantum of exchanged value internally converted into the ubiquitous GEMCoin currency and then the difference is reverted back to the currency actually used by the claimant of that difference. The parties do not need to be aware of the intermediate conversions, or they may specify exact terms of conversion for any currency they may possess and desire to use. But in cases where there is no agreement upon the currency conversion issue, the system's GEMCoin vehicle ensures that the transaction may be carried out without either party needing to acquire more of the other's currency or relinquish any of their own currency, because the transaction is completed by the exchange of GEMcoin. What is even more advantageous, is that whenever there arises a situation where many currency options are available under a certain set of conditions (such as the local jurisdiction and laws governing each party, the present value of the currencies held by each party and therefore available as options for use as the exchange medium in the hoped-for transaction), then there will also be a hierarchy of costs and benefits impinging upon each currency exchange option that is accessible to the parties for trading during the transaction, and therefore the software comprises algorithms for identifying such costs and benefits and consulting relevant public information such as legal information and other known factors, and to present those options and their relative advantages/disadvantages to each party to elect the most intelligent, suitable, and agreeable choice among among the available options. Thus, not only does the system facilitate cross-currency commerce, it also enables currency-agnostic commerce, it enables on-the-fly adjustments for current exchange rates among any pair of fiat currencies, and it further enables the identification of whichever reciprocal currency trade arrangement has the lowest transaction cost, finally offering the GEMCoin option where profitable.

The system of the present invention is more than just a payment platform, it is a payment selection engine, and an intelligence that effectively reduces the friction of many exchanges and transactions, thus providing unique incentives to members and a niche utility not found in more anticipated by the prior art card systems. Furthermore, the incorporation of a platform-specific cryptocurrency creates a novel economic system based upon a hybridization of decentralized peer-to-peer cryptocurrency networks and a centrally regulated cryptocurrency network. Many of the benefits and incentives realized by members of the system are proportional to the volume of GEMCoin in play among the parties to transactions, even when other currencies are involved.

The mining algorithm is decentralized and there is no premining allowance. Mining identifies coins by generating them at an algorithmically defined rate and assigning them to a first account holder based on a published rule, such as a rule declaring whoever happens to own the computer that won the competition to mine the next available coin is the first owner of that coin when it is generated. In the simplest example, the GEMCoin code is a modification of the Bitcoin code. Color features and watermarks are provided in the preferred embodiment of the GEMCoin code, which may store transaction information and user identification information in the data structure defining a coin. Importantly, in the preferred embodiment of the invention, GEMCoin is backed by the asset (or commodity) of diamonds at their recognized market value.

Mining activities are advantageously controlled with a Gateway. Novel means are provided for enabling the verification of transactions on the Block Chain with Clusters of Nodes separated into separate Division that holds parts of the Ledger to increase validation times and reduce the size of the ledger being held. Miners are organized into Communities that support and share with each other the coins mined, validation of new blocks and verification of transactions. Involvement of the mining community in the Dual Currency Exchange Software protocol helps to protect from attack with redundancy and multiple source verification of transactions. Algorithms facilitate the backing of GEMCash (an alternate name for a coin of the invention) with Diamonds at Wholesale value to create a “Book Value” floor for the currency and a way to control Volatility and inflation and deflation of the Coin. The invention enables

Third Party Mining of GEMCash coin, Third Party Valuation of the Coin's asset base to determine Book Value (Third party appraisal of Diamond asset that is backing the Coin); Third Party Value Controls (All diamonds kept by third party bank, with Escrow Agents in charge of redeemable diamonds for GEMCash coins); Central Management of GEMCash issuance into the market.

The Operating system for the dual currency card DALV (DCOS) manages incoming and outgoing digital currency amounts transferred. Reconciles with central Digital Currency Transaction Platform (DCTP) through the D-APP software. Labels digital currency with personal information of owner and transactional information. Exchanges digital currency for fiat and updates balances locally on Card or online accounts through D-APP to DCTP. Shows previous transactions. Shows balances in Digital and Fiat Currencies as of the date of the last D-APP Reconciliation. Accepts digital currency that has not been reconciled with the online account, whether bank account or digital currency wallet. Tracks fiat currency spending metrics (currency name, amount acquired versus amount spend, transaction records and statistical analyses), and also tracks available balances. Will track balances removed for placement into cold storage. Interfaces with security measures like the aforementioned fingerprint recognition means, and it executes password protections and encryption protocols. Interfaces with battery, charger, and energy management elements of the device, operates the screen and other input/output means, including the magnetic stripe and NFC components.

The Point of Interface and Reconciliation (POIR) module comprises hardware preferably based on the android tablet platform, but installed with proprietary software specially adapted for use in the present invention, which adaptation is necessitated by the unprecedented combination of modules and functions in the card as well as the system supporting the card, particularly the integration of a hybrid digital currency and so many interconnected means for converting units of value in a first currency or asset to units of value in a second currency or asset under a given set of circumstances. The POIR is the interface where the card communicates with the central server and authority of the network to reconcile, update, load, download, and otherwise manage the flow of information between each card and the whole network, between each member's account balance and each member's “off-line” or outstanding liabilities, and even tracking their location, personal behavioral data (log data), preferences, account balances and conversion rates, and so on. And when there are multiple owners of an asset, account, or card, the means for managing such circumstances are resolved by settings accessible to the user via the DCOS. Interfaces with the DCTP.

The D-APP element comprises software for installing and running on smartphones or other personal electronic devices, which software enables said devices to serve as nodes and/or access points to the network of the system and to the cards of the system. And, they provide an interface for members to connect with their cards via the internet to their online accounts, such as digital wallets, banking and checking accounts. Cell phones, laptops and tablets use the software to interface the card with online accounts using the DCTP. The DCTP holds the last update information locally (in the memory of the device with D-APP installed thereon) to recall for comparison when the user makes a subsequent reconciliation, and the D-APP takes advantage of the user interface of the typical personal electronic device to provide more engaging and extensive user experience via these devices than on the card itself.

The Digital currency transmission platform is a centralized proprietary software for controlling the transmission and reconciliation of digital and fiat currency accounts for member card holders on the network which also enables interfacing with existing debit and credit card networks (VISA, MasterCard, Amex, etc.). It exchanges fiat for digital and digital for fiat according to guidance from the central server or equivalent central administration means in the backend of the network where the centralized ledgers, and the software controlling them, manage and maintain the virtual and physical accounts of all, along with any other subsystems like the mining module that converts assets into and out of GEMCoin, from fiat currencies to the regulation of GEMCoin network dynamics, and from mining operations to commodity-backed pricing parameters that influence that exchange value of GEMCoin (e.g., parameters relating to the price of diamonds). In summary, the DCTP links the content of the cards on the network with the ultimate administrating authority that makes final executive decisions about the variables and status of assets and events recorded by the authoritative instances of the ledgers(s) and account balances for the whole system.

The gateway software module enables and validates mined or minted cryptocurrency, such as the GEMCoin cryptocurrency of the preferred embodiments. The software of the module comprises the logic specifying the structure and function of the blockchain of the cryptocurrency and the terms governing the means by which new coins are generated, whether by mining (the term used generically) or by unique and exotic variations of the standard Bitcoin protocol. Newly generated cryptocurrency (or other virtual asset) is validated and assigned to a wallet address according to rules established by the bitcoin protocol, which are amenable to customization to achieve any desired network behavior. The system of the present invention includes a variety of unique and previously described algorithms pertaining to all variable aspects of the bitcoin protocol. The bitcoin algorithm interfaces with mining “rigs,” which are any computer instructed to perform according to the mining protocol of a particular cryptocurrency, which may be performed on machines solely owned and possessed by the entity that owns a given network of the present invention, or alternatively and additionally, by anyone who downloads a corresponding mining client to use on their own personal computing devices. The latter system encourages a distributed network where the consensus is regarded as the authoritative version of the blockchain while the former proprietary mining system is convenient for ensuring the steady and predictable performance of the network as a whole. And, because the system provides means for enabling an administrator to manage the performance of all aspects of the system including the cryptocurrency modules and to modulate values, the system benefits from the active oversight of a party whose interests are aligned with those of the members, making it more robust, secure, and effective at meeting expectations of the company and its members consistently. The preferred embodiment of the mining software uses a proof of work SHA-256 algorithm but in this system permits the administrator to intervene when necessary or profitable to correct inefficiencies in the performance of this and other performance aspects of the cryptocurrency network. GEMCoin can alternatively or additionally be created directly by minting, such as by software provided in preferred embodiments of the verification platform, at the discretion of the central authority and with the expectation by members that the administrator will be faithful to protect their best interests. Such as system could not work on an open, non-member cryptocurrency network which was based solely on consensus, because of the risk of a self-interested party usurping the power to manipulate coin values and volumes, as well as the risks that mining efficiency will be manipulated along with the awarding of newly generated coins (e.g., including the well known risk of a hostile takeover of the network by a “51% attack”).

The DALV is associated with a number of accessories, comprising either or both hardware and software components, and in some stand-alone embodiments it may be sold as part of a kit. A first accessory is a battery charging adapter, and relatedly is a docking station with a built in charger. An alternative representation of the system illustrated in FIG. 2 is provided below:

### Section 1: GEMCoin Mining, Validation, Issuance, Storage and Conversion to Fiat

a. G.L.M.S—Gemcoin Local Mining Software
Local computers running proprietary mining software to interface with Gateway.
b. G.M.G.S—Gemcoin Mining Gateway Software
Used to regulate who mines and how much can be mined of GEMCoins to control inflation and deflation of the coins value. No difficulty Algorithm and is used instead we back the currency with a recognized and tabulated asset in the form of diamonds.
c. F.T.D.S—Centralized software to interface with digital currency wallets and fiat currency accounts for our miners and card holders. This software interfaces with existing banking and debit card network software to remove and place fiat currency bank accounts held by GEM TRUST for card holders.

### Section 2: Dual Currency Card Operating System—Point of Interface App—Dual Currency

### Exchange Software

a. D.C.O.S—The master software used inside the Dual Currency Card to manage the incoming and outgoing Digital Coins, to manage functions of the card and to watermark Gemcoins with personal and transactional information. Also will maintain balances of fiat and digital currency and convert digital to fiat and fiat to digital and update online accounts.
b. P.O.I.A—Downloaded to mobile devices like cell phones, laptops and tablets to interface with Dual Currency Card and the Dual Currency Exchange Software and home base to update digital and fiat currency accounts and exchange currency as well as move money between accounts. It is also used to reconcile previous transactions that were done during COLD or offline operations between Cards.
c. D.C.E.S—This software interfaces with the Point of Interface App, the home based software interfacing with the existing banking networks to update Fiat and Digital Currency accounts, move currency between accounts, do exchanges and spend currencies whether fiat or digital.
Section 3: Vendors Debit Card Processor unit—Debit Card Networks—GEM TRUST Interface software mentioned above.

### Additional Definitions

A multicurrency platform is a system comprising means for transferring, converting, and transacting among more than one type of currency, where a type of currency refers not only to fiat currencies issued by different national authorities but also alternative currencies comprising non-fiat stores of value redeemable in a marketplace or acceptable by any party for the satisfaction of debts and payments of any party.

A coin is a unit of cryptocurrency whenever the context is a virtual or digital context. A cryptocurrency may comprise logic that defines a coin on its network as any arbitrarily defined but constant quantum of value relative to the entire supply of a cryptocurrency. It is an express intent that the cards communicate with any current or future device which transmit digital currencies and related data such as private or public keys, wallet addresses, pricing in any and all digital currency formats, whether the transmission is active or passive from small or large device such as Smart Tags coming on the market. The card can also interface with online shopping sites and resources. With the Card's ability to not only purchase but display on the screen the pertinent information about the item, such as price, size, color, features and manufacturer.

Mining comprises the processes which generate coins in a cryptocurrency according to defined protocols. A miner is any computational device or algorithm that executes the mining function of a cryptocurrency. In the prior art, mining is generally performed by executing an algorithm (“proof of work”) or storing coin in a node (“proof of stake”) in a cryptocurrency network, but hybrid processes exist and theoretically there is an unlimited spectrum of means for accomplishing mining.

The term fiat currency as used herein refers to any currency that is manifested in a physical form and suitable for commerce, such as cash, paper money, coins, etc. A crypto currency, although perhaps destined to be accepted under the definition of “money,” is still regarded by most as merely “like money,” or an equivalent of money. This distinction shall not be limiting nor consequential herein unless explicitly stated as such.

Further functions and advantages are integrated into the various menu options within the customizable modules and software applications of the components throughout the network. For example, one innovation comprises an emergency response algorithm, which may be loosely termed as a “panic mode,” whereby a member user is able to move bitcoins from one account configuration to another via an automated flight to safety wallet transfer feature. If a panic button is pressed in a certain way, such as in a temporal sequence of depressions, the device immediately transfers digital assets to a predetermined remote location or secure storage are in memory, helping to prevent theft and extortion.

In embodiments of the invention comprising high resolution screens or video output displays, the device can and will display Digital Currency in the form of QR CODES, BAR CODES and Numeric Series of Numbers that can be scanned or photographed to transfer payment or receive payment. It can display Personal ID information such as a users picture, finger print or other personal identifying information. It can also be used to display product information as well as warnings that maybe transmitted from a nearby device or from an online alert that comes via the internet. Embodiments comprise a TINY PORT on the card to connect a cable for charging and transmission. A mini micro female connector optionally exists on the side of the card for charging or for wired input and removal of data. Embodiments comprise touch sensitive controls with hyperstatic feedback: the vibration that a user feels when typing on a screen of a cell phone to indicate that keys have been punched.

Bluetooth, other wireless, and various local networks independent of the internet can be used to update balances and validate transactions. The cards will update and validate and reconcile transactions if it is close to a Blue Tooth or NFC or all other local area wireless networks that maybe close to a LEDGER, on a Miners Computer that is then hooked on the Internet. Users are not limited to the Card Holders ability to have a cell phone or tablet hooked up to the Platform, to then connect with the Worldwide Ledger, since the ledger of the transactions are the same as the Bitcoin Ledger widely distributed, much like the Chinese in Hong Kong are now talking to each other, by passing the Internet which is being monitored and blocked by the Central Chinese Govt, so will the cards of the invention and Card Holders be able to use NFC and Blue Tooth as well as other Local Wireless transmission systems to Update their cards and balances off the widely distributed ledger holding their balances in both Cryto and Fiat Currencies as it is shared from this Platform with the entire Block Chain Ledger on every networked computer on a given system. For example, if a user were in Africa, and he did not have a cell phone or an internet connection, but one of the system's Miners has the ledger on his computer, which is also Blue Tooth or NFC etc. equipped, he can then accept the user's card's transaction, update it even if he is not currently online, but in close enough proximity to the card holder in need of Validation and Reconciliation. This can also happen where a HUGE WEB is created of Blue Tooth Devices or Thousands of Individual Cards or Cell phones creating a Wireless Network that eventually miles and miles away connects with the Ledger, which then uses its information to move Updated information back and forth to the Card that came into the wireless web then present.

It should be emphasized that the above described embodiments of the present invention exemplify some, but not all, possible implementations of the present invention and have been set forth in order to provide a clear understanding of its qualities. Those skilled in the art will appreciate that the conception upon which this disclosure is based may readily be utilized as a basis for designing of other structures, methods, and systems for carrying out the several purposes of the present invention. The following claims should be regarded as encompassing equivalent and various constructions insofar as they do not depart from the spirit and scope of the methods and devices consistent with the present invention.

I claim:

1. A portable multiple-currency apparatus comprising at least one input means for receiving input data; at least one processor means for processing data and for generating output data; at least one memory means for storing a plurality of instructions and for storing data; and at least one display means for generating graphical displays of data; wherein said plurality of instructions when executed by said at least one processor cause the at least one processor to operate with the display device and the at least one input device to:
(a) receive a command to execute a transaction for an amount of a first currency
(b) perform generate an output for executing the transaction
(c) display the generated outcome
(d) provide an award of the first currency according to the generated outcome
(e) determine a second currency
(f) provide an amount of the second currency.
